(19) United States
(12) Patent Application Publication
(10) Pub. No.: US 2015/0027158 A1
(43) Pub. Date: Jan. 29, 2015

(54) System for Transporting Condensed Water from a Vehicle's Air Conditioner to its Windshield Washer Reservoir

(71) Applicant: Mahmud Ahmad, Maalot (IL)

(72) Inventor: Mahmud Ahmad, Maalot (IL)

(73) Assignee: Avner Omri, Herzeliya (IL)

(21) Appl. No.: 14/338,595

(22) Filed: Jul. 23, 2014

(30) Foreign Application Priority Data
Jul. 23, 2013 (IL) 227613

(51) Int. Cl. B60S 1/48; B60H 3/02; B60S 1/50

(52) U.S. Cl. CPC B60S 1/48; B60S 1/50; B60H 3/024
USPC 62/288

(57) ABSTRACT

A system, designed to transport condensed water from the vehicle's air conditioner to the vehicle's windshield washer reservoir that comprises an air conditioner, a reservoir, and tubing. The tubing transports condensed water from the air conditioner to the reservoir. The system may also include a condensed water collection container and a pump. One tube transports the condensed water from the air conditioner to the condensed water collection container, and a second tube transports water from the condensed water collection container to the windshield washer reservoir via the pump. The invention also refers to a kit that comprises two tubes, a condensed water collection container, and a pump and is designed to transport condensed water from the air conditioner to the reservoir.

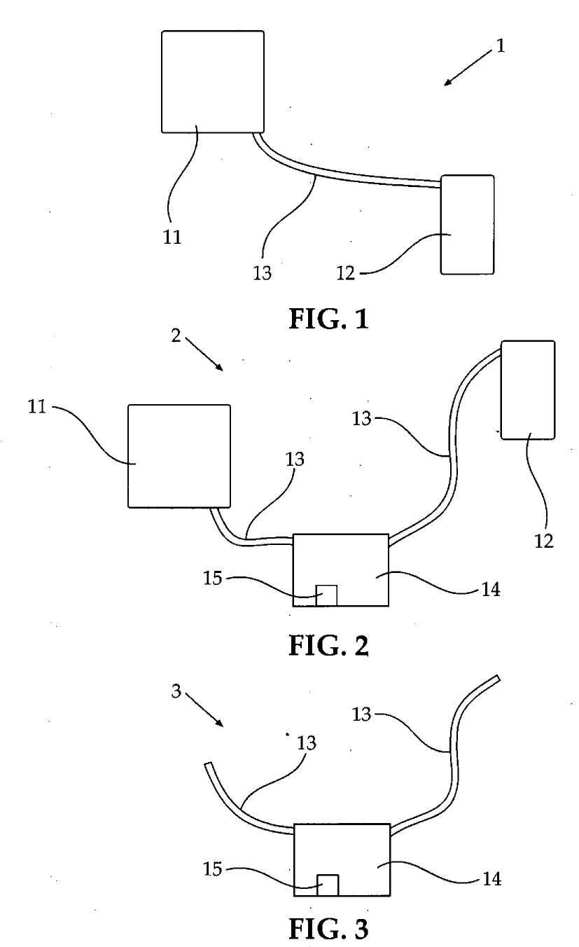

### TECHNICAL FIELD

A system designed to transport condensed water from a vehicle's air conditioner to the vehicle's windshield washer reservoir.

### BACKGROUND ART

All vehicles are equipped with a windshield washer system comprising windshield wipers, nozzles, tubing, a pump, and a reservoir designed to contain water or a special windshield washer fluid (hereinafter “the reservoir”). Since regular tap water contains calcium and magnesium (“hardness ions”) that lead to scaling, which in turn clogs the nozzles, the reservoir is typically filled with a special fluid that is purchased at gas stations or other relevant shops. It is relatively expensive to fill the reservoir with special washer fluid and users often forget to fill the reservoir and are caught with no windshield washer fluid in the reservoir. The invention, subject of the present patent application, offers a good response to these problems.

### DESCRIPTION OF THE DRAWINGS

The intention of the drawings attached to the application is not to limit the scope of the invention and its application.

The drawings are intended only to illustrate the invention and they constitute only one of its many possible implementations.

Drawing No. 1 presents a schematic description of the system (1).

Drawing No. 2 presents a schematic description of the system (2).

Drawing No. 3 presents a schematic description of the kit (3).

### THE INVENTION

The main objective of the present invention is to provide a system that enables to use condensed water from a vehicle's air conditioner to wash the vehicle's windshield. Since condensed water from air conditioners is scale-free, it is suitable for use in the vehicle's windshield washer system.

The system (1), subject of the invention, comprises the following components: the vehicle's standard air conditioner (11), the vehicle's standard windshield washer reservoir (12), and tubing (13) for transporting the condensed water from the air conditioner (11) to the reservoir (12). The system (1) is described schematically in Drawing No. 1 and it refers to cases in which the reservoir (12) is positioned lower than the air conditioner's water outlet in a way that enables the water to flow into the reservoir by force of gravity. Obviously, when the windshield washer reservoir (12) is full, surplus water will spill over. It is also obvious that when the air conditioner (11) is not operating and there is no supply of condensed water to the reservoir (12), the user may, and should, dill the reservoir with special windshield fluid, as is customary.

The system (2), subject of the invention, refers to cases in which the windshield washer reservoir (12) is positioned higher than the air conditioner's water outlet, and it is described schematically in Drawing No. 2. The system (2) comprises the air conditioner (11), the reservoir (12), tubing (13), a condensed-water collection container (14), and a pump (15). A tube (13) transports the water by force of gravity into the condensed-water collection container (14), and the pump (15) pumps the water through another tube (13) into the reservoir (12).

The kit (3), subject of the invention, refers to a kit, which may be purchased separately and self-installed in the vehicle, that is designed to transport condensed water from the air conditioner to the windshield washer reservoir. The kit (3) comprises tubing (13), a condensed-water collection container (14), and a pump (15), and is described schematically in Drawing No. 3. The kit (3) is designed to be installed in existing vehicles and not necessarily by vehicle manufacturers. The kit (3) is installed as follows: one tube (13) is connected from the air conditioner's water outlet to the condensed-water collection container (14), and a second tube (13) is connected from the condensed-water collection container (14) to the top of the windshield washer reservoir (12), via the pump (15).

What is claimed is:

1. A system, designed to transport condensed water from the vehicle's air conditioner to the vehicle's windshield washer reservoir, that comprises an air conditioner, a reservoir, and tubing; wherein said tubing transports condensed water from said air conditioner to said reservoir.

2. A system, designed to transport condensed water from the vehicle's, air conditioner to the vehicle's windshield washer reservoir, that comprises an air conditioner, a water collection container, a pump, and two tubes; wherein one tube transports condensed water from said air conditioner to the water collection container; wherein the second tube transports water from said collection container to said reservoir, via said pump.

3. A kit designed to transport condensed water from the vehicle's air conditioner to the vehicle's windshield washer reservoir that comprises two tubes, a water collection container, and a pump.
